(19) United States
(12) Patent Application Publication
(10) Pub. No.: US 2003/0140093 A1
(43) Pub. Date: Jul. 24, 2003

(54) Method and apparatus for providing content over a distributed network

(76) Inventor: Cory L. Factor, Cleveland, MN (US)

Correspondence Address: Kurt J. Niederluecke, BRIGGS AND MORGAN, 2200 First National Bank Building, 332 Minnesota Street, Saint Paul, MN, 55101, US

(21) Appl. No.: 10/053,006

(22) Filed: Jan. 23, 2002

(51) Int. Cl. G06F 15/16

(52) U.S. Cl. 709/203

(57) ABSTRACT

The present invention provides a method and apparatus for capturing content, particularly text, graphic, and video feeds, including live video feeds, indexing and segment a file into individual files, converting the individual files into an appropriate format for transmission over the internet, adding the appropriate metadata to the file, and loading the converted files onto a website with the appropriate hyperlinks for downloading by visitors to the site.

### FIELD OF THE INVENTION

The present invention relates generally to a method and apparatus for providing content over a distributed network and particularly to a method and apparatus for providing all or selected portions of content originally produced in one or more media formats to a distributed network with minimal human intervention.

### BACKGROUND OF THE INVENTION

The rapid growth of networked communications systems, most importantly, the internet, as well as associated technologies, has provided new and unparalleled avenues for the dissemination to a broad spectrum of the planet's populace of all types and kinds of information in a variety of media formats. In the parlance of the internet, information in its various presentation formats (such as text, graphs, video, audio, etc.) and in its various transmission and storage formats (such as but not limited to html, mp3, mpg, avi, gif, bmp, etc. file formats), is known as “content” and those who produce content are known as “content providers.”

The capability for such widespread content distribution has correspondingly fueled a desire by both the content providers and the content recipients to have the content provided in the shortest possible time after its creation. Where text only is to be transmitted, this has proved to be relatively easy for the industry. Where large files requiring large amounts of bandwidth are being provided or where the content is found in several different formats—graphics, video, audio, and text, for example—this has proven to be a time consuming and/or labor intensive operation.

Providing information to internet websites in a timely manner is important to many businesses. By way of example only, many television news programs now routinely place all or substantially all of their daily news broadcasts on their websites for accessing by the public over the internet following their broadcasts. Typically, such broadcasts include both video and text segments and may include graphical presentations with audio overlays. The video segments may include pre-recorded video portions that were shown during the live broadcast, live remote video segments, as well as the video of the live broadcast itself. The text portion may include the text provided to the news anchors via a teleprompter.

To provide the broadcast to the internet, the broadcast will be saved to a computer hard drive. Following the broadcast, a group of technicians will then slice the broadcast into the appropriate news segments for uploading to the website server. The station may provide either all or a portion of the actual video broadcast of a particular story or simply that portion of a story read by the newscaster from the teleprompter. The video portions of the program will be segmented into the respective news stories, provided with a title or other identifier, and then uploaded to the station's website with the appropriate hypertext links. Other stories, such as those read by the anchors, may be segmented into video and/or the text of their statements may be provided to the website. Obviously, this process is an expensive, labor intensive, time consuming operation.

More specifically, the individual video stories are converted into a video file in the appropriate format for a streaming video provided over the internet; the appropriate metadata is added to the video file, and the files are uploaded to the station's website with the appropriate hyperlinks. The text and graphics of the broadcast is handled similarly, although the text files are converted into different formats, of course.

As noted, this process of providing the broadcast to the internet for interested internet users to view is time consuming and labor intensive. It would be desirable, therefore, to provide a new method for providing such news content to the internet that was less time consuming and involved less labor.

### SUMMARY OF THE INVENTION

It is an object of the present invention to provide a method and apparatus for providing content to an internet website that is not subject to the disadvantages of the prior art.

It is another object of the present invention to provide a method and apparatus for providing content to an internet website that requires minimal human intervention.

It is still another object of the present invention to provide a method and apparatus for providing content to an internet website that costs less than prior art methods and apparatus.

It is still yet another object of the present invention to provide a method and apparatus for providing television newscast content to an internet website.

It is another object of the present invention to provide a method and apparatus for providing television newscast content to an internet website at reduced costs and greater efficiencies than the prior art.

The foregoing objects of the present invention are provided by a method and apparatus for capturing content, particularly text, graphic, and video feeds, including live video feeds, converting the feeds to an appropriate format for transmission over the internet, adding the appropriate metadata to the file, and loading the converted files onto a website with the appropriate hyperlinks for downloading by visitors to the site.

More specifically, the present invention provides a method and apparatus for automatically capturing and combining content from a plurality of sources, converting the files into the appropriate format for distribution over the internet or other distributed network, adding the appropriate and any other desired metadata, and uploading the content in its new format to the distributed network with hyperlinks for accessing the information. In the context of a television news broadcast, the present invention will operate as appropriate relative to the recorded live broadcast, recorded and live remote video, graphics such as maps and photographs, and the text version of the words spoken by the anchors.

### BRIEF DESCRIPTION OF THE FIGURES

FIG. 1 is a schematic illustration of a content transfer system for transferring selected newscast content from a live television newscast to a website for subsequent downloading and viewing by a visitor to the website.

FIG. 2 is a flow chart illustrating an embodiment of the present invention.

FIG. 3 is a schematic diagram illustrating the segmentation of a content file using a metadata file in accord with an aspect of the present invention.

### DETAILED DESCRIPTION OF THE INVENTION

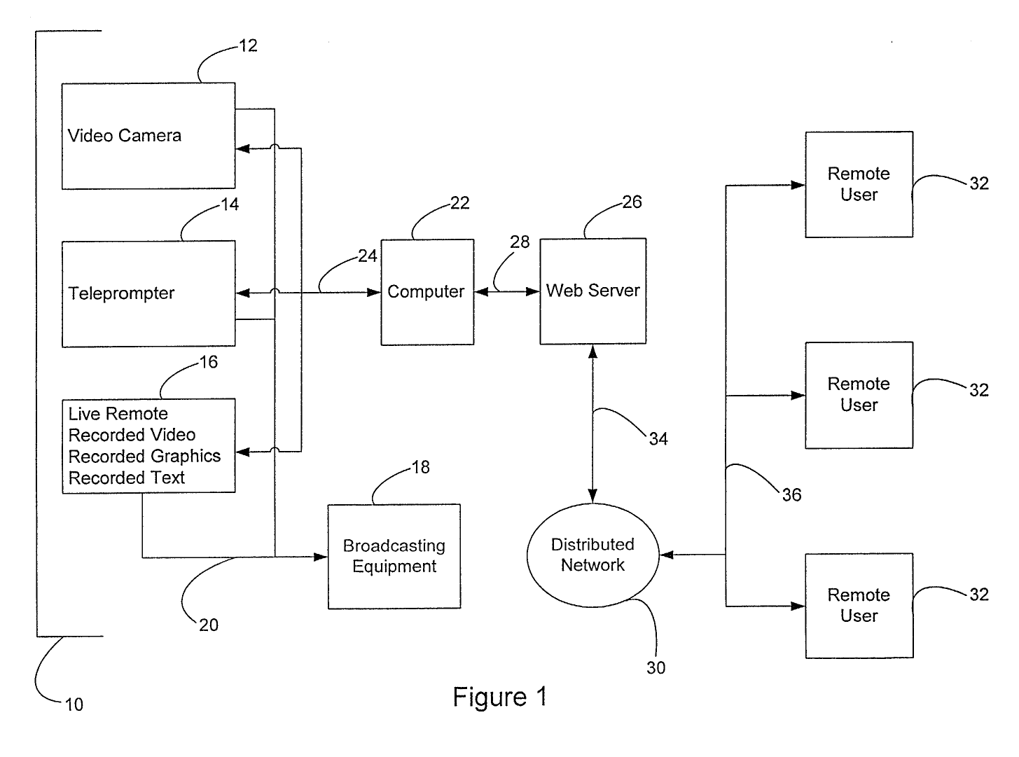

FIG. 1 provides a representative illustration of the type of apparatus useful with the present invention. It will be understood that this is a highly schematic figure and that many alternatives to the apparatus shown in FIG. 1 could find use with the present invention.

As seen in FIG. 1, an apparatus 10 useful with the present invention could include a video camera 12 recording a live broadcast such as a television news broadcast. As is familiar to most viewers of such broadcasts, they typically include live segments, including one or more anchors specializing in news segments such as the general news, weather, and sports. Typically, the anchors read from a script prepared before the broadcast. The timing of the presentation of the various portions of such a broadcast are usually carefully timed and scripted and displayed to the anchors on teleprompters 14 placed within the view of the anchors but not within the view of the video camera 12. In addition to reading news stories, the anchors typically will introduce other segments, such as live remote video segments from a news or sports scene or prerecorded video segments along with the appropriate accompanying graphics, such as photos or weather maps and with or without accompanying text, all of which may be provided to the viewing audience through other video equipment, including video recoding devices and computers, as indicated at 16. The content provided by apparatus 12, 14, and 16 will be in turn provided to the station broadcasting equipment 18 over the appropriate lines 20. Equipment 18 will in turn provide the broadcast over the airwaves, cable, and other communication modes to viewers, all as is well known in the art.

In addition, the apparatus 12, 14, and 16 will also provide content to a computer 22 over a line 24. The computer 22 will, in accord with the present invention, process the various content inputs provided by the apparatus 12, 14, and 16 to place the content into a format suitable for distribution over a distributed network. Once this processing has been completed, the converted content will be provided to a web server 26 over a line 28. The web server 26 in turn will be accessible by a distributed network 30 comprising at least one remote user 32 through communication lines 34 and 36.

It will be understood that the foregoing description of FIG. 1 is illustrative and that other alternatives to the present invention will be readily appreciated by those of skill in the art. For example, the communication lines 20, 24, 28, 34 and 36 could be wire or wireless communication systems.

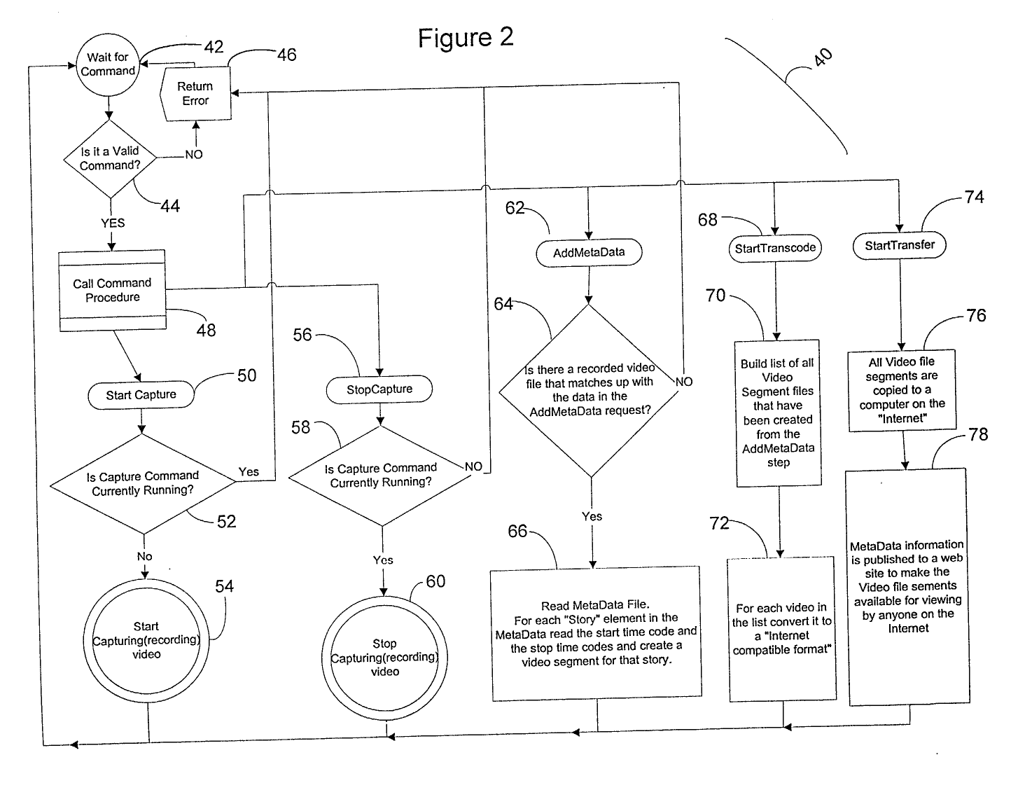

Referring now to FIG. 2, the present invention will be described relative to the flow chart illustrated there. The process 40 shown in FIG. 2 will be generally understood as being implemented by computer 22 shown in FIG. 1. The computer 22 will wait for the appropriate system command as at 42 and upon receiving a command, will perform a validation check as at 44 to determine if it the command is valid. If not, an error will be returned as at 46 and the system will return to the wait state as at 42. If the command is validated at 42, the call command procedure will begin as at 48.

Depending upon the particular command received, different processes will be followed. An initial command will be the capture command, which will begin capture of content as indicated at 50. Before beginning content capture, however, a check will be made to determine if there is already a capture command running as at 52. If yes, an error will be returned as at 46. If no, then content, such as video content, will begin to be recorded as at 54.

The computer or other appropriate video device will continue to capture content until another command is received at 42. Once again, the appropriate validity check will be made at 44. If validated, the call command procedure at 48 will begin and the computer will initiate the appropriate command procedure. If the command procedure is a capture command, then an error will be returned after the check at 52 is performed. If the command is to stop capture as at 56, then a check will be performed at 58 to determine if there is a capture command currently running as at 58. If no capture command is running, then an error will be returned at 46 and the system will once again wait for another command as at 42. If there is a capture command running, then the capture will be stopped at 60, the captured content file will be closed, and the system will await the next command.

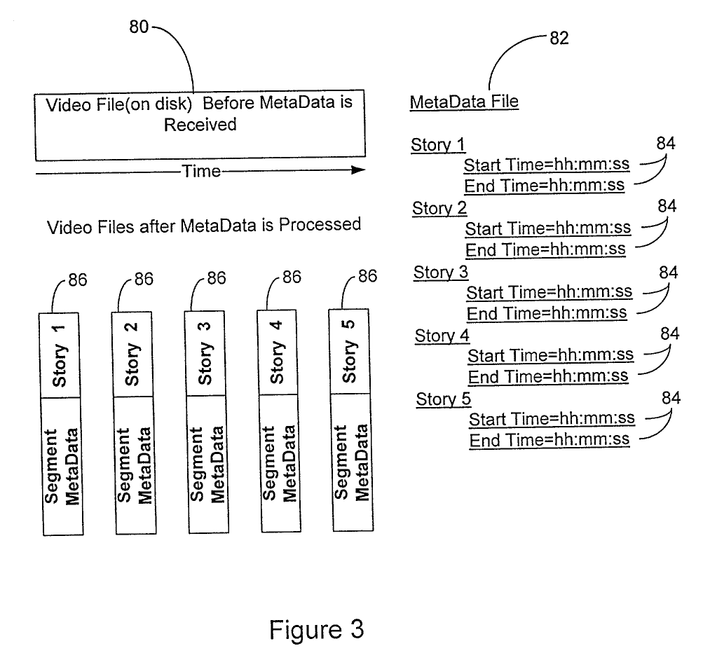

When the next command is received at 42, the command will again be validated and the appropriate procedure will be initiated. Where the command is a start capture command or stop capture command, the aforedescribed procedures will be followed. If the command received is to add metadata as at 62, a check will made to determine if there is a captured content file that matches the data in the add metadata command as at 64. If not, an error will be returned at 46. If there is such a file, then a previously prepared metadata file will be read as at 66. This file will include the start and stop time codes of each of the segments or story elements in the captured file. At this step, the captured video will thus be associated with appropriate metadata to create a video segment of each particular story as will be explained in more detail in FIG. 3.

Once a file has been associated with the appropriate metadata, then when the system 40 receives the appropriate command, transcoding of the file can begin. Thus, when the Start Transcode command is received through the above-described validation procedure as at 68, a listing of all of the files created by the AddMeta step 66 will be made at 70. Each file in the list will then be converted into the desired format compatible for distribution over a distributed network such as the internet as at 72. For example, video files could be converted into *.rm files, *.asf files, *.avi files, *.mpg files, or *.mov files, to name but a few of the currently available file types while audio files could be provided in *.mp3 format among others. It will be understood by those skilled in the art that the present invention is not limited to such currently available file types, but will also encompass future developed file types and standards.

Following conversion of the files at 72, the files will be transferred to the appropriate server for access by the distributed network users. Thus, when a Start Transfer command is received at 74, all of the converted file segments will be transferred or copied to a server as at 76. Such a server may be accessible through the internet, for example.

In addition to transferring the files to a computer accessible to the distributed network, the metadata for that file will be published to a website as at 78. The published metadata will include hypertext links that will allow the remote user, such as an individual at a home computer, to click on a hypertext link and play the file through a web browser or download for playing by a stand alone program.

The foregoing description has been generally related to captured video files, but can also be applied to text and graphics files or any kind of file available over a distributed network.

Referring to FIG. 3, the segmentation of the file will be more fully explained. As seen in the Figure, a file 80, here a video file, to be segmented for uploading to a web server is provided in some electronic format, such as a video file on a computer hard drive. A separate metadata file 82 is provided that includes the information desired to be associated with the various stories to be segmented from file 80. Typically, such a file 82 will include, at least, the start and end times 84 of the individual stories on file 80. This will enable the present invention to index the stories on the file 80 and to segment the stories on file 80 into individual files 86. That is, a computer will use the start and end times in file 84 to identify the beginning and end of individual stories in file 80 to segment the file 80 into a plurality of individual files 86, each of which will include, in the context of a news broadcast by way of example only, one news story. A story could, for example, be the video of an anchor reading a story or a previously recorded story broadcast over the live news broadcast. In the example shown in FIG. 3, the file 80 includes five individual stories having individual start and end times 84, all of which are found in the associated metadata file 82. This information is then used to segment the five stories into the five individual files shown at 86. It will be understood, of course, that the file 80 could contain any number of individual stories and that FIG. 3 is but an example of the operation of the present invention. As noted earlier, the metadata file 84 may also include story titles and hypertext links used by remote users to access the files on the internet.

While the discussion of the foregoing file 80 has principally related to a video file, such a file could also be a file including principally text, such as the text provided over a teleprompter to the anchors. This would allow the present invention to segment a file and provide, by way of example only, the text of a story read by an anchor to the internet as a file separate from the video file of the anchor actually reading the story.

The metadata file can be prepared manually, but preferably is also electronically prepared. For example, where a news broadcast is controlled by means of software that also controls the teleprompter and the timing of the various news segments, then that information can be converted into a metadata file with the appropriate time codes. Referring to FIG. 2, such information could include predetermined metadata information published at 78, thus essentially eliminating the need to create such information after a news broadcast. For example, a news segment could be given a title in the teleprompter and the title could be converted to a hypertext link as part of the metadata file and associated with the appropriate video, text, or graphic segment at 66. This link would then be published at 78 and used by the remote user to access the associated news segment over the internet.

The present invention, then, provides an apparatus and method for automatically taking recorded content, associating it with the appropriate metadata, and making the content available to users of a distributed network such as the internet. The present invention having thus been described, other modifications, alterations, or substitutions may now suggest themselves to those skilled in the art, all of which are within the spirit and scope of the present invention. For example, while the present invention has been described with reference to placing the converted files on the web only after the completion of a news broadcast, such a process could occur after each news segment is completed. It is therefore intended that the present invention be limited only by the scope of the attached claims below.

What is claimed is:

1. A method for providing content in at least one electronic format to a distributed network, said method comprising:
providing the content in the at least one electronic format to a computer;
capturing the content as an electronic file on the computer;
providing indicia for identifying the electronic file in an electronic format to the computer;
associating the identifying indicia with the electronic file;
converting the file to a format suitable for distribution over the distributed network; and
providing the file and associated identifying indicia to a server accessible over the distributed network.

2. The method of claim 1 wherein the content comprises a live video feed.

3. The method of claim 2 wherein the identifying indicia comprises metadata including hypertext links.

4. The method of claim 1 wherein the distributed network is the internet and the identifying indicia comprises metadata including hypertext links.

5. The method of claim 1 wherein the content includes a live video feed and at least additional content in at least one additional format from the group including text, audio, or graphics.

6. The method of claim 5 wherein the distributed network is the internet and the identifying indicia comprises metadata including hypertext links.

7. The method of claim 1 wherein the content is a television news broadcast and includes information in video format and at least additional content in at least one additional format from the group including text, audio, or graphics.

8. A computer program stored in electronic format for providing content to a distributed network, said program being provided for being loaded onto a computer and said program:
receiving the content in the at least one electronic format;
capturing the content as an electronic file on the computer;
receiving indicia for identifying the electronic file in an electronic format;
associating the identifying indicia with the electronic file;
converting the file to a format suitable for distribution over the distributed network; and
providing the file and associated identifying indicia to a server accessible over the distributed network.

9. The program of claim 8 wherein the content comprises a live video feed.

10. The program of claim 9 wherein the identifying indicia comprises metadata including hypertext links.

11. The program of claim 8 wherein the distributed network is the internet and the identifying indicia comprises metadata including hypertext links.

12. The program of claim 8 wherein the content includes a live video feed and at least additional content in at least one additional format from the group including text, audio, or graphics.

13. The program of claim 12 wherein the distributed network is the internet and the identifying indicia comprises metadata including hypertext links.

14. The program of claim 12 wherein the identifying indicia comprises metadata including hypertext links.

15. The program of claim 14 wherein the distributed network is the internet.

16. The program of claim 8 wherein the content is a television news broadcast and includes information in video format and at least additional content in at least one additional format from the group including text, audio, or graphics.
